(19) United States
(12) Patent Application Publication
(10) Pub. No.: US 2026/0359550 A1
(43) Pub. Date: Nov. 12, 2026

(54) GENERATIVE MATHEMATICAL TRANSCREATION

(71) Applicant: Adobe Inc., San Jose, CA (US)

(72) Inventors: Raghav Kapoor, Sunnyvale, CA (US); Nedim Lipka, Campbell, CA (US); Eunyee Koh, San Jose, CA (US)

(73) Assignee: Adobe Inc., San Jose, CA (US)

(21) Appl. No.: 19/205,691

(22) Filed: May 12, 2025

(51) Int. Cl. G06F 40/111; G06N 5/022

(52) U.S. Cl. CPC G06F 40/111; G06N 5/022

(57) ABSTRACT

Techniques related to generative mathematical transcreation are described. In an example, a processing device is operable to receive a mathematical expression having a numerical quantity and a unit that is extracted from a digital document, and initiate a machine-learning model to generate a context of the digital document. The processing device is further is operable to receive an input defining a target context, and determine a target quantity and a target unit for the numerical quantity and the unit based on the target context using a mapping. The mapping defines a unit-to-context relationship with the context of the digital document. A target mathematic expression is formed by the processing device based on the target quantity, the target unit, and the mathematical expression. The processing device is operable to present the target mathematical expression for display in a user interface.

### BACKGROUND

Mathematical transcreation adapts numerical content across contexts, languages, and cultural frameworks while preserving original meaning and intent. Conventional approaches implement manual processes or simplified automations that are time consuming and error prone, struggling to attain full context awareness or accurate transformations of diverse numerical representation. Machine learning approaches attempt to automate mathematical transcreation but are challenged with context specific terminology and addressing new or underrepresented scenarios, such as compound units, context-specific measurements, and conversion factors, like currency rates, that possibly change over time.

### SUMMARY

Generative mathematical transcreation techniques are described. An example processing system implements a transcreation model that receives a mathematical expression having a numerical quantity and a unit extracted from a digital document and generates a target mathematical expression, which adapts the mathematical expression for a target context. To enhance efficiency, accuracy, and performance by transcreating math expressions, the processing system applies a combination of machine learning and deterministic processing techniques. A machine-learning model (e.g., a large language model) provides context awareness to the transcreation model using machine learning to generate a context of the digital document, as well as automatically extract numerical quantities and units that are appropriate for that context. The target context is identifiable in various ways, including based on a user input defining the target context or information that indicates an intent of the transcreation. Based on the target units, the numerical quantities, and the units based on output from the learning model, the transcreation model deterministically generates a transcreation of the mathematical expression. The transcreation model identifies equivalent target units for the target context based on the units and the context, for instance, using a mapping, referred to in examples as a content unit dictionary, which defines a unit-to-context relationship. Conversion factors between the original and target units are calculated, e.g., using a sparsely or non-fully connected knowledge graphic configured as a conversion graph. The mapping and the conversion graph are modifiable, for example, to rename non-standardized units with standardized names or adjust conversion factors (e.g., currency rates) that change over time.

Once applied to the numerical quantities, the conversion factors produce target quantities, and the target mathematical expression for the target context is formulated using the target quantities and the target units. A function implements a modified unit-aware shunting-yard algorithm that enhances accuracy and efficiency formulating the transcreation, including for compound unit expressions, convoluted expressions, and multi-unit calculations. The target mathematical expression is output for display in a user interface to support transforming numerical concepts between contexts, which is useful for generating context-specific documents, tables, charts, graphs, and other digital content, providing versatility across different data types, applications, and domains. The techniques improve overall comprehension and engagement with numerical and mathematical content across ethnic, regional, and educational divides, contributing to unified global understanding and communication of mathematical principles. Applying generative mathematical transcreation based on the described techniques can enhance conventional applications (e.g., real time audio transcription, digital content production or playback, and speech translation services). Reliably accurate mathematical transcreations obtained from applying complementary machine-learning and deterministic approaches are efficiently generated for a target context based on audio, text, or other digital content expressing mathematical concepts or numerical content in a different context.

This Summary introduces a selection of concepts in a simplified form that are further described below in the Detailed Description. As such, this Summary is not intended to identify essential features of the claimed subject matter, nor is it intended as an aid in determining the scope of the claimed subject matter.

### BRIEF DESCRIPTION OF THE DRAWINGS

The detailed description includes references to the accompanying figures. Entities represented in the figures are indicative of one or more entities and thus reference is made interchangeably to single or plural forms of the entities in the discussion.

FIG. 1 is an illustration of an example environment that is operable to implement techniques described herein related to generative mathematic transcreation.

FIG. 2 depicts an example system that is operable to implement generative mathematic transcreation.

FIG. 3 depicts an example context unit table that is configured as a context unit dictionary of the example system depicted in FIG. 2.

FIG. 4 depicts an example unit conversion data structure that is configured as a conversion graph of the example system depicted in FIG. 2.

FIG. 5 illustrates examples of mathematic transcreations performed using the techniques described herein related to generative mathematic transcreation.

FIG. 6 depicts an example user interface of an examples system that is operable to implement learning based mathematic transcreation.

FIG. 7 is a flow diagram depicting an algorithm as a step-by-step process, which is performable by a processing device to perform learning based mathematic transcreation.

FIG. 8 is a flow diagram depicting an algorithm as another step-by-step process, which is performable by a processing device to perform learning based mathematic transcreation.

FIG. 9 shows an example of a guided diffusion model according to aspects of the present disclosure.

FIG. 10 shows an example of a U-Net according to aspects of the present disclosure.

FIG. 11 shows an example of a method for conditional media generation according to aspects of the present disclosure.

FIG. 12 shows a diffusion process according to aspects of the present disclosure.

FIG. 13 shows a flow diagram depicting an algorithm as a step-by-step procedure for training a machine-learning model according to aspects of the present disclosure.

FIG. 14 shows an example of a method for training a diffusion model according to aspects of the present disclosure.

FIG. 15 shows an example of a computing device according to aspects of the present disclosure.

FIG. 16 shows an example of an apparatus according to aspects of the present disclosure.

FIG. 17 illustrates an example system including various components of an example device usable as any type of computing device as described and/or utilized with reference to FIGS. 1-16 to implement examples of the techniques described herein.

### DETAILED DESCRIPTION

### Overview

Mathematical transcreation adapts numerical content across contexts, languages, and cultural frameworks while preserving original meaning and intent. Conventional approaches implement manual processes or simplified automations that are time consuming and error prone, struggling to attain full context awareness or transforming diverse numerical representation. Without comprehensive context understanding, these approaches introduce inaccuracies and lack capability to transform diverse numerical representations for each possible transcreation scenario, particularly for complex multi-unit conversions and convoluted numeric expressions. Machine learning approaches attempt to automate mathematical transcreation but struggle with correct interpretations of context-specific terminology and interpreting new, unrepresented scenarios, such as compound units, context-specific measurements, and conversion factors that possibly change over time, like currency rates. For example, a large language model (LLM) by nature is tuned for linguistic understanding and is unreliable in situations that involve processing numbers or accurately interpreting mathematical concepts described using a combination of numbers, units, and text. Additional challenges persist in adapting to regional, domain-specific, or utility-based syntax and preferences, potentially affecting original meaning and causing inconsistent global interpretations of mathematical content. These limitations hinder the ability to transform mathematical expressions of numerical entities and associated units efficiently and accurately between contexts, impacting the generation of context-specific digital content across various data types, applications, and domains.

An example system implements techniques for generative mathematical transcreation. The system (e.g., a content processing system) executes a transcreation model that receives a mathematical expression having a numerical quantity and a unit extracted from a digital document and generates a target mathematical expression for a target context. The transcreation model leverages a combination of machine learning and deterministic processing to transform the mathematical expression efficiently and accurately between different contexts. The transcreation model applies machine-learning techniques to provide context awareness for defining the context of the digital document and, in at least one example, is also used for automatically extracting numerical quantities and units from the mathematical expression. A machine-learning model (e.g., a large language model) of the transcreation model analyzes the input to determine contextual information and identify the numerical quantities and associated units of the mathematical expression. The machine-learning model enables the system to handle diverse input types, including text documents, spreadsheets, database query results, images with graphical numerical information, and audio and video streams with numerical information.

The system then deterministically maps between the extracted units and appropriate target units based on the determined contexts. The context of the digital document and units, for instance, are deterministically mapped to the target context using a mapping that defines a unit-to-context relationship that identifies equivalent target units using a compact and efficient data structure, e.g., a context unit table of a context unit dictionary. Conversion factors between the original and the target units are deterministically computed, by using a conversion graph. The conversion graph, for instance, represents a sparsely connected (e.g., non-fully connected) graph structure with nodes and edges connecting nodes. The nodes and edges represent relationships and conversion factors between different units of measure. When applied to the numerical quantities, the conversion graph calculates conversion factors for converting the numerical quantities into target quantities for the target context. Rather than generate the conversion factors, different paths of the conversion graph are quickly and efficiently traversed to calculate conversion factors, even for conversions between nodes not directly connected by an edge. In addition to improving memory efficiency, the conversion graph is configurable to allow automatic update capability that adjusts individual conversion factors that change over time, such as currency rates or non-standardized units. Integrating a conversion graph as described herein addresses challenges deterministically adapting to regional, domain-specific, and utility-based or functionally equivalent scenarios.

The target mathematical expression is formulated using the target quantities and target units. A unit-aware shunting-yard function, for instance, facilitates processing of compound unit expressions and intricate mathematical statements involving multiple unit types. Unit conversions are treated as unary operators within the expression evaluation process. The function enables correct interpretation of expressions with different currencies or units, e.g., £100=$129, which supports transcreating compound unit expressions, e.g., converting miles per gallon to kilometers per liter, multi-unit calculations, e.g., $100+£100=$229, and other complex scenarios. This approach allows for deterministic evaluation of convoluted expressions and multi-unit calculations, ensuring accuracy even in complex scenarios. The system outputs the target mathematical expression, which is usable to quickly adapt and generate digital content (e.g., text, documents, graphs, charts, infographics) for different possible contexts. For example, the techniques reconstruct numerical concepts for context-specific documents, tables, charts, graphs, and other digital content across various data types, applications, and domains. This approach enables efficient and accurate mathematical transcreation across diverse scenarios, improving overall comprehension and engagement with numerical and mathematical content across ethnic, regional, and educational divides. The system versatility in handling various input types and complex unit conversions contributes to unified global understanding and communication of mathematical principles.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Production Environment

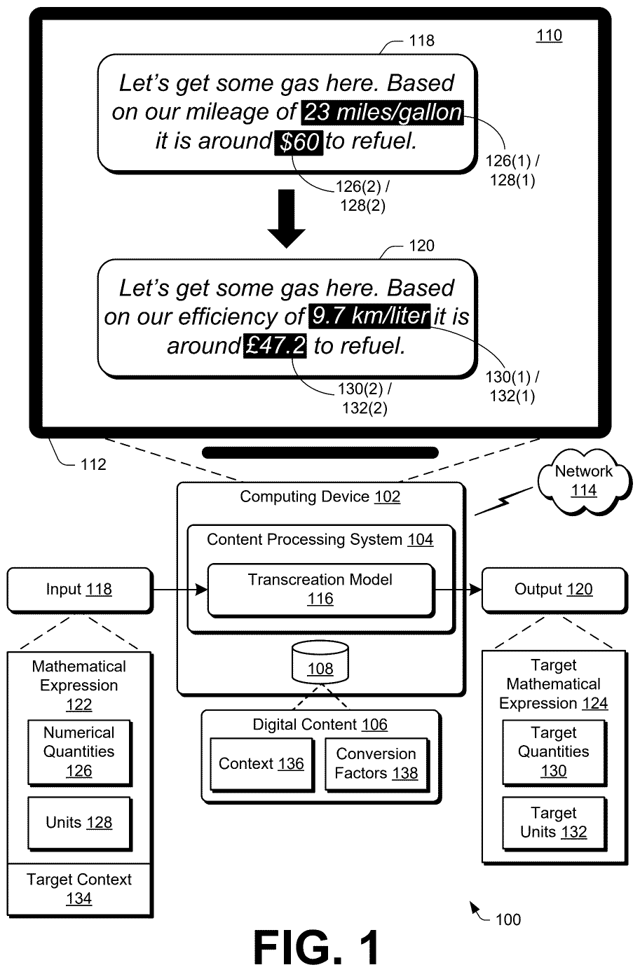

FIG. 1 is an illustration of an example environment 100 that is operable to implement techniques described herein related to generative mathematic transcreation. The environment 100 includes a computing device 102, which is configurable in a variety of ways.

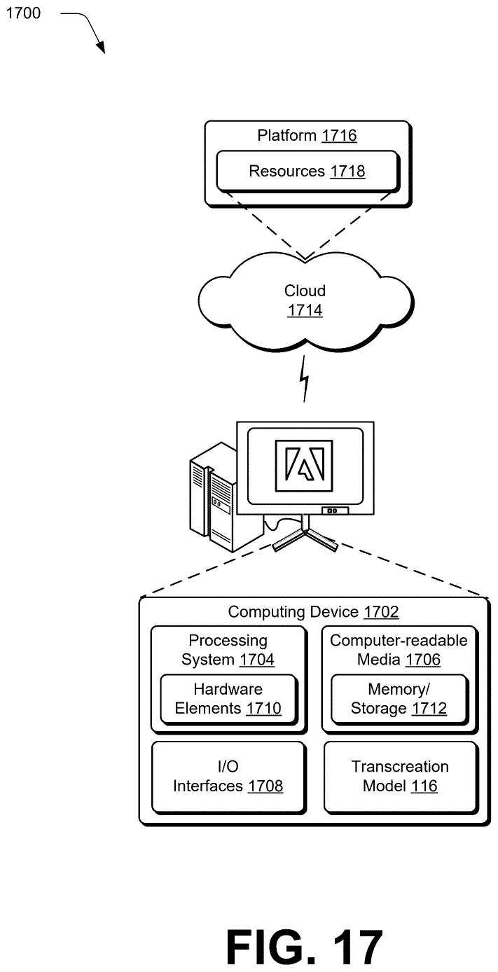

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device is shown, the computing device 102 is also representative of a plurality of different devices (e.g., a computing system), such as multiple servers utilized by a business to perform operations “over the cloud” as described in FIG. 17.

The computing device 102 is illustrated as including a content processing system 104. The content processing system 104 is implemented at least partially in hardware of the computing device 102 to process and transform digital content 106, which is illustrated as being maintained in storage 108 of the computing device 102. Such processing includes creation of the digital content 106, modification of the digital content 106, and rendering or re-rendering of the digital content 106 for presentation in a user interface 110, e.g., for output by a display device 112. Although illustrated as implemented locally at the computing device 102, functionality of the content processing system 104 is also configurable in whole or in part through functionality available via the network 114, such as part of a web service or “in the cloud”. The content processing system 104 implements a transcreation model 116 for processing digital content 106.

The transcreation model 116 receives an input 118 and generates an output 120, performing mathematical transcreation using learning models (e.g., an artificial intelligence model, a machine-learning model, a large language model) to understand context and extract numerical quantities and units from the input 118. This enables the content processing system 104 to handle diverse input types, including text documents, spreadsheets, database query results, images with graphical numerical information, and audio and video streams with numerical information. The input 118 and output 120 are displayed in the user interface 110 on the display device 112, enabling efficient transcreation without specialized knowledge or manual conversion of complex structures.

The input 118 to the transcreation model 116 includes a mathematical expression 122 for a context 136 and a target context 134. The input 118 expresses numerical data in various formats, including as portions of text documents, spreadsheets, database query results, images with graphical numerical information, or audio and video streams with numerical information. The input 118 is a digital document in variations, which includes a numerical expression among other document information that gives context for the numerical expression. As illustrated in FIG. 1, the input 118 includes text stating, “Let's get some gas here. Based on our mileage of 23 miles/gallon it is around $60 to refuel.” The mathematical expression 122 includes numerical quantities 126 and units 128, with “23” as a first numerical entity 126(1), “60” as a second numerical entity 126(2), “miles/gallon” as a first unit 128(1), and “$” as a second unit 128(2).

The target context 134 defines attributes that affect the interpretation of mathematical expressions, such as geographical regions, measurement systems, or domain-specific requirements. Attributes of the target context 134 that can improve transcreation across different contexts and situations include geographic region, function associated with the input, numerical precision preferences, custom or industry-specific units, or overall theme and intended use.

The transcreation model 116 processes the input 118 to generate the output 120, including a target mathematical expression 124. The output 120 includes target quantities 130 and target units 132 representing the mathematical expression 122 in the target context 134. For example, the output 120 shown in FIG. 1 displays “9.7” as a first target quantity 130(1), “47.2” as a second target quantity 130(2), “kilometers/liter” as a first target unit 132(1), and “£” as a second target unit 132(2). The output 120 includes a description stating “Let's get some gas here. Based on our fuel efficiency of 9.7 kilometers/liter it is around £47.2 to refuel.” The transcreation model 116 maps between the context 136 and target context 134, for instance, using a mapping that defines a unit-to-context relationship. This mapping process identifies the target units 132 equivalent between the given contexts, enabling accurate conversion between measurement systems and units, in a deterministic manner.

The transcreation model 116 is designed with flexibility in mind, allowing for efficient on-device implementation. In variations, the computing device 102 utilizes a smaller, instruction-tuned version of a machine-learning model for local inference. This on-device model is specifically fine-tuned on a well-curated dataset relevant to mathematical transcreation tasks. By adapting to the format while keeping processing on the client's side, this approach enables the system to perform local inference without having constant network connectivity. This on-device capability is useful in scenarios where privacy is a concern, or in environments with limited or unreliable network access. The smaller model size also reduces computational resource requirements, making the transcreation process more efficient on mobile devices or low-power computing systems. Despite reduced size, the on-device model maintains high accuracy in context understanding and entity extraction, leveraging transfer learning techniques to preserve the capabilities of larger models.

To initiate the transcreation process, a user provides the input 118 with the mathematical expression 122. The transcreation model 116 extracts a context 136 and identifies the numerical quantities 126 and units 128, e.g., using a machine-learning model. The machine-learning model enables the system to handle diverse input types and complex scenarios, improving overall comprehension and engagement with numerical and mathematical content across different contexts. The context 136 is derived by analyzing the input 118 to determine relevant attributes such as geographic region, domain, intended use, or other contextual factors that influence how the mathematical expression is to be interpreted and transcreated. This analysis involves examining surrounding text, metadata, or other contextual clues within the input 118. The machine-learning model processes the input to generate a summary or extract features that inform the context. Based on this context 136, the transcreation model 116 creates a contextual understanding that guides subsequent steps in the transcreation process, such as unit mapping and conversion factor computation.

The target context 134 is provided through user input or automatically determined based on document metadata or content analysis. Upon specifying the target context 134, the transcreation model 116 maps between the context 136 and target context 134, for instance, using a mapping that defines a unit-to-context relationship. This mapping process identifies appropriately, the target units 132 for the given contexts, enabling accurate conversion between measurement systems and units, in a deterministic manner (e.g., without reliance on a learning model).

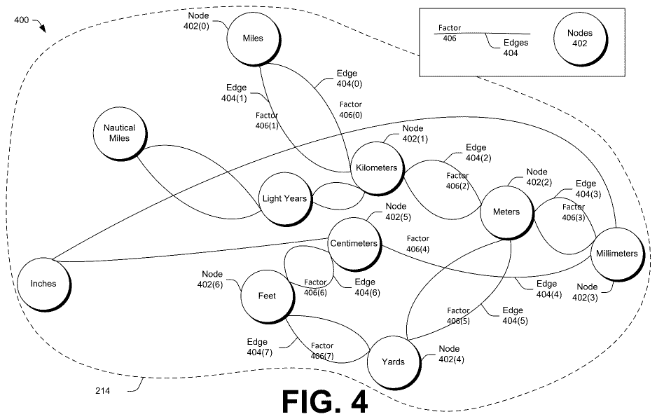

The transcreation model 116 computes conversion factors 138 to create target quantities 130 from the numerical quantities 126. A knowledge graph as shown in FIG. 4 is an example data structure that is useful for deterministically deriving the conversion factors 138. The knowledge graph represents relationships between different units of measurement, with nodes representing individual units and edges representing conversion factors between connected nodes. This structure allows for efficient handling of unit conversions without achieving a fully connected graph of each possible conversion. In variations, the computing device 102 accesses digital content 106 including conversion information through at least one of the storage 108 or the network 114 to compute the conversion factors 138 by updating intermediate conversion factors embedded in the knowledge graph. This capability allows the transcreation model 116 to handle a wide range of conversion scenarios and maintain up-to-date conversion factors. The conversion factors 138 are computed by combining intermediate conversion factors that appear along edges of a shortest path between original and target unit nodes of the knowledge graph, enabling memory-efficient storage and updates for dynamic conversions like currency rates.

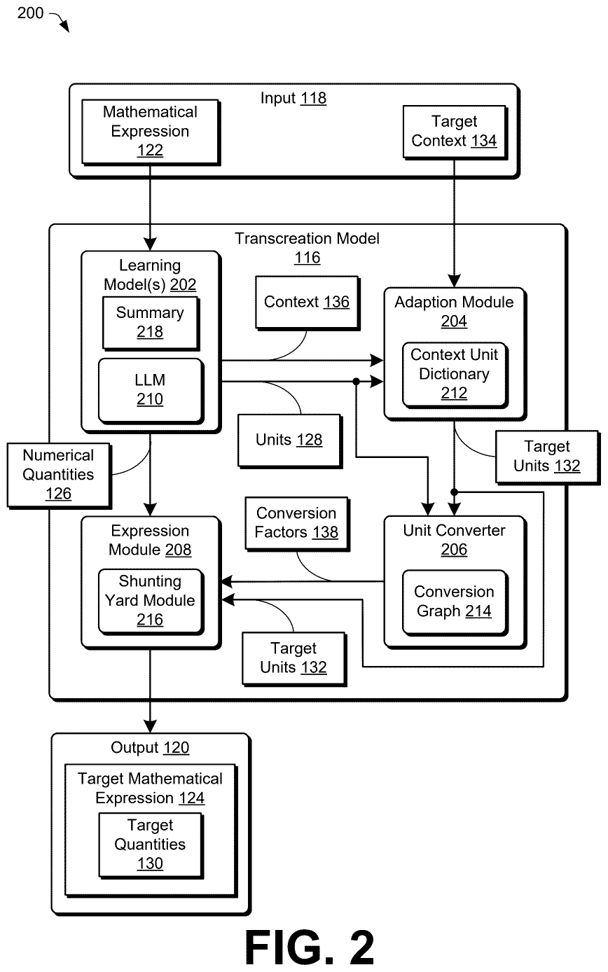

To formulate the target mathematical expression 124, the transcreation model 116 employs a unit-aware shunting-yard function, such as the unit-aware shunting yard module 216 shown in FIG. 2, handling complex multi-unit and compound unit expressions accurately. This approach supports precise evaluation of convoluted expressions and multi-unit calculations, even in scenarios involving different currencies or units. The unit-aware shunting-yard function treats unit conversions as unary operators, allowing for deterministic evaluation of expressions with different currencies or units. For example, the function handles expressions like “$100+£100=$229”. The function traverses the knowledge graph to identify paths between original and target unit nodes, combining intermediate conversion factors along the path to produce final conversion factors. This enables efficient handling of unit conversions without achieving a fully connected graph of each possible conversion. The graph-based approach allows for compact storage of conversion factors and straightforward updates, which is useful for dynamic conversions such as currency rates that change frequently. The unit-aware shunting-yard function enhances accuracy and efficiency in formulating transcreations, including for compound unit expressions, convoluted expressions, and multi-unit calculations.

This comprehensive approach, as illustrated in FIG. 1, demonstrates capability to perform efficient and accurate mathematical transcreation across diverse scenarios. The transcreation model 116 enables the computing device 102 and the content processing system 104 to implement techniques and perform operations that improve overall comprehension and engagement with numerical and mathematical expressions in digital content across different ethnic, regional, and educational divides, contributing to a unified global understanding and communication of mathematical principles. The versatility of the transcreation model 116 in handling various input types and complex unit conversions, combined with an ability to adapt to different contexts and scenarios, automates transforming numerical concepts between contexts, including in furtherance of generating digital content across various data types, applications, and domains, including context-specific documents, tables, charts, graphs, and other digital content.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture of Generative Mathematic Transcreation

The following discussion describes generative mathematic transcreation techniques that are implementable utilizing the previously described systems and devices. Aspects of each of the procedures are implemented in hardware, firmware, software, or a combination thereof. The procedures are shown as a set of blocks that specify operations performed by one or more devices and are not limited to the orders shown for performing the operations by the respective blocks.

FIG. 2 depicts an example system 200 that is operable to implement generative mathematic transcreation. The system 200 illustrates an implementation of the transcreation model 116 of the content processing system 104, shown in greater detail than in FIG. 1. By integrating large language models with deterministic mapping, conversion, and other transcreation techniques, the system 200 can perform efficient and accurate mathematic transcreation.

The system 200 comprises interconnected components that work together to perform generative mathematical transcreation. The transcreation model 116 leverages a combination of machine learning and deterministic processing techniques to transform the mathematical expression 122 between different contexts. In the illustrated example, the system 200 implements a transcreation model 116 that receives an input 118 including a mathematical expression 122 and a target context 134. The system 200 generates an output 120 including a target mathematical expression 124 with target quantities 130.

When a user provides the input 118, the transcreation model 116 first applies machine-learning techniques to provide context awareness for defining the context 136 and automatically extracting numerical quantities 126 and units 128 from the mathematical expression 122. The transcreation model 116 includes learning models 202 that process the mathematical expression 122 to identify numerical quantities 126 and units 128. When a user provides the input 118, the learning models 202 analyze the text, image, or other digital content from the input 118, extracting relevant numerical information and associated units.

The learning models 202 represent machine learning models trained on diverse datasets of mathematical expressions and contextual information. These models, including a large language model (LLM), LLM 210, are autoregressive and not originally designed for mathematical calculations, often have difficulty with precise numerical computations, even when provided with conversion factors 138. To address this limitation, the transcreation model 116 employs an approach coupling the LLM 210 with a unit-aware shunting yard module 216 that accommodates units along with operators. This hybrid approach leverages the capabilities of the LLM 210 in context understanding and entity extraction while enabling accurate mathematical operations.

The learning models 202 incorporate error handling and regeneration mechanisms to promote accuracy of numerical quantities 126 and units 128. After initial extraction, the system verifies the extracted information by searching the extracted information back in the original text of the input 118. If discrepancies are found or if the extracted quantities are determined to be incorrect based on contextual analysis, the system initiates a regeneration process. This process involves re-analyzing the relevant portion of the input 118 using alternative parsing strategies or more focused machine learning models. For example, if an extracted unit is ambiguous (such as “m” which represents meters or minutes), the system will re-examine the surrounding context to disambiguate and correct the extraction. In cases where regeneration is implemented, the system employs iterative refinement, gradually adjusting its extraction parameters until a high-confidence result is achieved. This error handling and regeneration capability can enhance the robustness of the system, promoting accurate transcreation even in challenging scenarios with complex or ambiguous numerical expressions. In the context of the system 200, the LLM 210 or other model of the learning models 202 is configured to verify that the numerical quantities 126 and the units 128 are supported by the input 118 by reprocessing the digital document of the input 118 with the LLM 210 or other model of the learning models 202 to search back through the digital document with the LLM 210 or other model of the learning models 202 for the numerical quantities 126 and the units 128. If there is a discrepancy and at least one of the numerical quantities 126 or the units 128 is unsupported by the digital document of the input 118, the LLM 210 or other model of the learning models 202 is configured to regenerate the document summary 218 to address the discrepancies. For example, a prompt input to the LLM 210 requests that the document summary 218 include references to specific numerical quantities or units, or to indicate that previous quantities or units are incorrect. Then, the LLM 210 or other model of the learning models 202 is configured to reverify that numerical quantities 126 and units 128 are supported by the digital document of the input 118 by again, researching back through the digital document with the LLM 210 or other of the learning models 202 for the numerical quantities 126 and the units 128.

The learning models 202 support processing various input formats, such as text documents, spreadsheets, database query results, images, audio and video streams, or spoken language, by extracting numerical data and units from the input medium. To process mathematical quantities in the input 118, the learning models 202 treat them differently from the rest of the text. The learning models 202 extract numerical quantities 126 and units 128 from a document summary 218. This approach is performed because units are often unclear or positioned next to the quantity in the mathematical expression 122. After extraction, the system 200 verifies the numerical quantities 126 and units 128 by searching them back in the text of the input 118 to promote correctness. In cases where extracted quantities are incorrect, the system 200 regenerates results to maintain accuracy. For example, given the input 118, “The car travels at 60 mph on the highway,” the learning models 202 identify “60” as one of the numerical quantities 126 and “mph” as the associated one of the units 128. Based on attaining a contextual understanding of the input 118 (e.g., a digital document), the learning models 202 are configured to disambiguate abbreviations in the input 118, or misspelled units. For instance, the learning models 202 distinguish between “N” for Newton and “m” for meters or milliseconds based on the surrounding context, aiding accurate interpretation of the input 118.

The LLM 210 analyzes the input 118 to determine a context 136, including surrounding text and metadata, to understand the broader context of the mathematical expression 122. The LLM 210 generates a document summary 218 of a digital document input (including surrounding text), which aids in understanding the context 136. This document summary 218 helps answer questions about the document's region, theme, use of special units, measurement precision, and any specific formatting related to ethnic, cultural, or localized settings. In variations, the LLM 210 is a neural network-based model trained on large amounts of text data, enabling understanding of complex language patterns and contextual nuances. In practical applications, the LLM 210 allows the system 200 to adapt to various domains and industries, interpreting domain-specific terminology and conventions. The LLM 210 is implemented on the computing device 102 as a smaller, instruction-tuned model for local inference, adapting to the format while maintaining client-side processing. This comprehensive context understanding can promote accurate and culturally appropriate mathematical transcreation when generating the target mathematical expression 124 and target quantities 130 for the output 120.

The adaption module 204 receives the context 136 and target context 134. The adaption module 204 determines transformations to convert the mathematical expression 122 to the target context 134. For example, if the context 136 is U.S. customary units and the target context 134 is metric, the adaption module 204 identifies the target units 132 in the metric system that correspond to the units 128 relative the U.S. customary units of measure. The adaption module 204 processes complex scenarios such as context localization, where units differ across regions and among different contexts for those regions. For instance, in a cooking context, cups and spoons are common measurements in the U.S., in addition to miles and miles per gallon as indicators of U.S. driving distances and fuel efficiency. In Europe and Asia, standard milliliters or grams are typical cooking units used, and kilometers and kilometers per liter are terms for describing driving contexts that occur outside the U.S. Some contexts transcend multiple regions. For example, as mentioned above, Europe and Asia are two different regions that use similar terms for describing driving distances and fuel efficiency. In jewelry contexts across the globe, gemstones and diamonds are universally measured in carats, regardless of regional differences in measurements for mass observed across other contexts. The adaption module 204 uses a context unit dictionary 212 to map between units 128 and target units 132 based on contextual information and regional differences. The context unit dictionary 212 includes regional standards, industry-specific conventions, and common unit systems. The adaption module 204 enables the system 200 to handle complex scenarios, such as converting between different currency systems while accounting for exchange rates and local conventions (e.g., decimal separators, thousands separators). The adaption module 204 adapts to utility-based localization, where based on the utility or formality in tone, different contexts have differences in precision. For example, scientific measurements use precise numbers, while construction workers often use approximate calculations.

The context unit dictionary 212 within the adaption module 204 maps between units 128 and target units 132 based on the context 136 and the target context 134. The context unit dictionary 212 includes mappings of units across various domains and regions. For instance, the context unit dictionary 212 includes entries mapping “miles per gallon” to “kilometers per liter” for fuel efficiency conversions between U.S. and metric systems. The context unit dictionary 212 handles currency adaptation, format and precision adaptation, and custom unit adaptation, enabling the system to perform accurate transcreations across a range of scenarios. The context unit dictionary 212 is structured as a multi-dimensional lookup table, associating units with their equivalents across different contexts. The context unit dictionary 212 supports the system 200 ability to handle specialized units, such as converting “barrels of oil equivalent” to “cubic meters of natural gas” in the energy industry, promoting accurate transcreation across diverse fields. The system 200 then employs deterministic processes to map between the units 128 and the target units 132 appropriately based on the determined contexts.

The unit converter 206 computes conversion factors 138 for converting between units 128 and target units 132. The unit converter 206 includes the conversion graph 214, which represents relationships between different units of measure as nodes connected by edges. The unit converter 206 takes the units 128 and target units 132 as inputs and uses the conversion graph 214 to determine conversion paths and compute appropriately the conversion factors 138. For example, when converting from miles to kilometers, the unit converter 206 traverses the conversion graph 214 to find the edge connecting the miles and kilometers nodes, which has an associated multiplication factor of approximately 1.60934. The unit converter 206 handles complex multi-unit conversions by finding paths through multiple nodes and edges in the conversion graph 214. This enables transforming compound units like “miles to kilometer” and “gallons to liter” by combining conversions for edges along a path that connects corresponding original and target nodes.

The conversion graph 214 is useful for handling complex unit systems and maintaining up-to-date conversion factors. In real-world applications, the graph structure allows for updates of dynamic conversion factors, such as currency exchange rates, without rebuilding the conversion system. For example, when converting between currencies, the system traverses the graph to find the efficient conversion path, potentially using intermediate conversions through a base currency. The approach enables the system to handle a wide range of conversion scenarios and maintain up-to-date conversion factors, particularly for dynamic conversions like currency rates that change frequently. The context unit dictionary 212 and the conversion graph 214 are configured for ease in updating (e.g., based on checking for updated units) allowing for the addition of new units or renamed units in the context unit dictionary 212. As another example, the ease of updates enables modification of the conversion factors 138 in the conversion graph 214 as measurement standards evolve or new industry-specific units emerge.

In variations, the unit converter 206 employs a breadth first search function in variations to efficiently navigate the conversion graph 214 and find a shortest path between units. This function systematically explores each of the vertices of the conversion graph 214 at the present depth prior to moving on to the vertices at the next depth level. By using breadth first search, the unit converter 206 determines an efficient conversion path between units 128 and target units 132, reducing the number of intermediate conversions and find a shortest possible path, including in complex scenarios involving multiple unit types or when direct conversion factors are not available.

The expression module 208 processes the numerical quantities 126 and conversion factors 138 to generate target quantities 130. The expression module 208 applies the conversion factors to the original numerical values while preserving the mathematical structure of the expression. For instance, when converting the expression “5 miles+3 kilometers,” the expression module 208 ensures that both distances are converted to a common unit before performing the addition. The expression module 208 handles scenarios such as evaluating expressions with different currencies or units, for example, “$100+£100=$229”. The expression module 208 implements mathematical parsing and evaluation techniques to handle complex expressions involving multiple units and operations. The expression module 208 enables the system to transcreate intricate mathematical formulas, such as physics equations or financial calculations, while maintaining the integrity of the original expression across different unit systems. The module handles compound unit expressions and convoluted expressions, promoting accurate transcreation in scenarios involving multiple unit types and mathematical operations.

The expression module 208 adapts charts and graphs based on the transcreated mathematical expressions. When processing the input 118 that includes graphical representations of data, the expression module 208 works in conjunction with the learning models 202 to analyze and extract relevant information from these visual elements. The system identifies axis labels, data points, and scales used in charts and graphs. Once the numerical quantities 126 and units 128 are extracted from these graphical elements, the expression module 208 applies appropriately the conversion factors 138 to transform the data. This process involves adjusting scales on both axes and potentially altering the shape of curves or heights of bars in histograms. The output 120 includes reconstructed charts and graphs that accurately represent the data using the target units 132, promoting consistency between the visual representation of the information and the transcreated text.

The target mathematical expression 124 is formulated using the target quantities 130 and target units 132, employing a modified unit-aware shunting-yard function to handle compound unit expressions and intricate mathematical statements involving multiple unit types. The unit-aware shunting yard module 216 within the expression module 208 processes the numerical quantities 126 and conversion factors 138 to generate target quantities 130. The unit-aware shunting yard module 216 implements a modified version of the shunting yard algorithm, adapted to handle unit conversions as part of the expression evaluation process. The module tokenizes the input expression, applies unit conversions, and generates a postfix notation of the transcreated expression. The modified unit-aware shunting-yard function treats unit conversions as unary operators within the expression evaluation process, enabling interpretation of expressions with different currencies or units. The unit-aware shunting yard module 216 handles complex mathematical expressions with mixed units. In real-world scenarios, the module enables transcreation of expressions such as “50 km/h in 2 hours+5 miles,” applying unit conversions and preserving the order of operations. This capability supports scientific or engineering applications where maintaining precise relationships between quantities is beneficial. The module's ability to handle compound unit expressions and multi-unit calculations supports transcreation across a range of complex mathematical scenarios.

The unit-aware shunting yard module 216 implements a unit-aware shunting yard function designed to transform mathematical expressions from a context to a target context. The unit-aware shunting yard module 216 configures the expression module 208 to implement accurate and efficient transcreation of mathematical expressions across different unit systems and contexts. For example, the unit-aware shunting yard module 216 implements a calculator procedure ρ, which is expressed mathematically as target mathematical expression T for a context C: T_{target}=ρ (Tᵢₙᵢₜᵢₐₗ, Cᵢₙᵢₜᵢₐₗ, C_{target}).

To transform the mathematical expressions T between the context and the target context C, the unit-aware shunting yard module 216 implements three main steps, which include: tokenization of the mathematical expression Tᵢₙᵢₜᵢₐₗ for the context Cᵢₙᵢₜᵢₐₗ, creation of a reverse polish notation (RPN) of the tokenization of the mathematical expression Tᵢₙᵢₜᵢₐₗ, and calculation of the target mathematical expression T_{target} for the target context C_{target}.

The unit-aware shunting yard module 216 represents units as unary operators Ounit, each of which has higher precedence than regular operators O_{regular}. The unit operators function as conversion factors from units Uᵢₙᵢₜᵢₐₗ to target units U_{final}, derived from the conversion graph 214 in previous steps. Mathematically, this is representable as Oᵤₙᵢₜ∈ƒ(Uᵢₙᵢₜᵢₐₗ, U_{final}) and O_{regular}∈{+, −, ÷, ×, &, . . . }.

As one example, the unit-aware shunting yard module 216 receives the mathematical expression 122, which describes “100 N/m2+50 lbf/ft2”. The unit-aware shunting yard module 216 receives an indication that the target context 134 is the U.S. The unit-aware shunting yard module 216 initializes the conversion factors 138 based on the conversion graph 214, e.g., {(N, lbf)→0.224809, (m, ft)→3.28084, (euro, pounds)→0.86, (dollars, pounds)→0.73, . . . }.

In variations, the unit-aware shunting yard module 216 implements mathematical transcreation by executing several interconnected algorithms. As one example, when processing expressions T, the unit-aware shunting yard module 216 first handles unit conversion by examining whether units are identical, in which case the unit-aware shunting yard module 216 returns one of the conversion factors 138 equal to one. For units being converted (e.g., the conversion factors 138 are not equal to one), the unit-aware shunting yard module 216 may check the conversion factors 138 obtained from the unit converter 206 for direct conversion values and compute the reciprocal for inverse conversions. If the conversion factors 138 are not appropriate (e.g., no equivalent conversion factor exists), the unit-aware shunting yard module 216 may flag an error in the transcreation.

Next, to process the expression T, the unit-aware shunting yard module 216 begins with tokenization, where the unit-aware shunting yard module 216 employs regex patterns to tokenize numerical values and operands of the mathematical expression into individual components. The regex patterns recognize numerical values including decimals, alphabetic characters representing units, and various mathematical operators. For example, when processing an expression such as “100 N/m\hat{ }2+50 lbf/ft\hat{ }2”, the unit-aware shunting yard module 216 generates tokens such as [‘100’, ‘N’, ‘/’, ‘m’, ‘\hat{ }’, ‘2’, ‘+’, ‘50’, ‘lbf’, ‘/’, ‘ft’, ‘\hat{ }’, ‘2’], creating a tokenized math expression of the original expression T.

Following tokenization, the unit-aware shunting yard module 216 performs unit preprocessing by iterating through the tokens and applying appropriately the conversion factors 138 when units follow numerical values. This process transforms unit symbols into their corresponding conversion factors, enabling mathematical operations across different measurement systems. For example, the processed tokens for the example expression become [‘100’, ″, ‘0.224809’, ‘/’, ‘3.28’, ‘\hat{ }’, ‘2’, ‘+’, ‘50’, ″, ‘1’, ‘/’, ‘1’, ‘N’, ‘2’], where the units are replaced with numerical conversion values.

The unit-aware shunting yard module 216 then creates a reverse polish notation of the tokenized math expression to handle operator precedence effectively. The reverse polish notation conversion utilizes an output queue and an operator stack, for instance, sequentially processing each token according to whether that token represents a number, operator, or parenthesis. In continuing the above example, by adhering to established shunting yard algorithm principles, the unit-aware shunting yard module 216 generates a reverse polish notation representation such as [100.0, 0.224809, ″, 3.28, 2.0, ‘\hat{ }’, ‘/’, 50.0, 1.0, ″, 1.0, 2.0, ‘\hat{ }’, ‘/’, ‘+’] for the example expression, which enables sequential processing of the numerical values and operands.

In the final step, the unit-aware shunting yard module 216 computes the target mathematical expression based on the conversion factor and by sequentially processing tokens from the reverse polish notation to produce the target mathematical expression 124. Using a stack-based approach, the unit-aware shunting yard module 216 processes the reverse polish notation tokens sequentially, performing operations when encountering operators and pushing results back onto the stack. For the example expression, this evaluation by the unit-aware shunting yard module 216 outputs the target mathematical expression 124 that describes a result of 52.089 lbf/ft2, accurately converting and combining values across different unit systems.

This process enables the unit-aware shunting yard module 216 to handle complex multi-unit expressions with precision, performing accurate conversions while preserving mathematical integrity across diverse contexts and unit systems. By treating units as high-precedence operators and integrating conversion factors into the mathematical evaluation process, the unit-aware shunting yard module 216 enhances the accuracy and reliability of context-aware mathematical transcreations. The unit-aware shunting yard module 216 approach to unit handling and mathematical evaluation forms a deterministic component to enhance and improve robustness of the overall transcreation model's ability to generate contextually appropriate mathematical expressions.

This approach enables the system 200 to perform efficient and accurate mathematical transcreation across diverse scenarios, improving overall comprehension and engagement with numerical and mathematical content across ethnic, regional, and educational divides. The system's versatility in handling various input types and complex unit conversions contributes to unified global understanding and communication of mathematical principles. Additionally, the system's modular design allows for integration of new conversion techniques and unit systems, facilitating adaptability to future developments in mathematical notation and measurement standards.

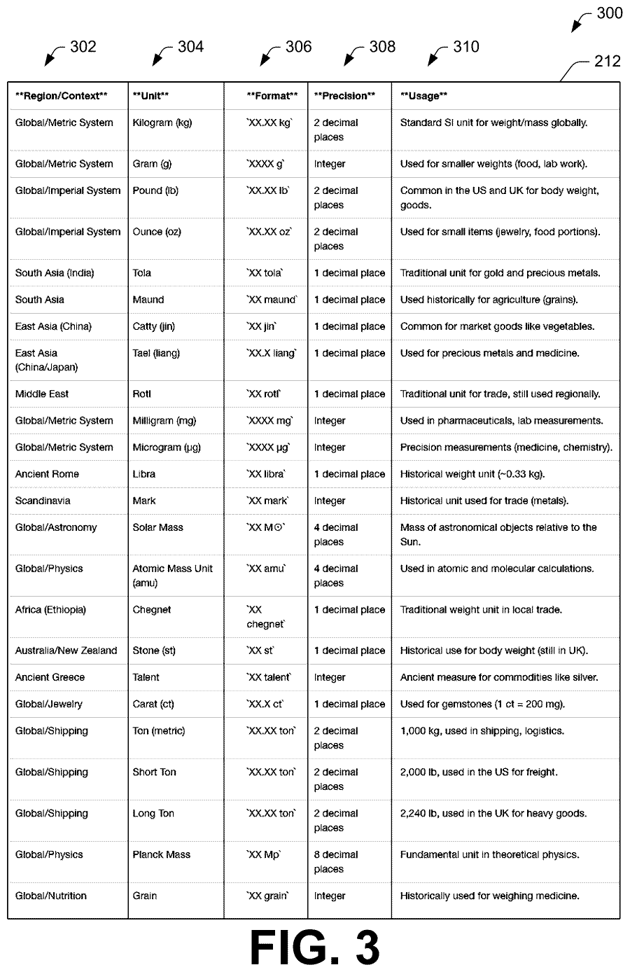

FIG. 3 depicts an example context unit table 300 that is configured as a context unit dictionary 212 of the example system 200 depicted in FIG. 2. The context unit table 300 represents a table for mass, defining mappings between different units of mass and their contextual information, serving as a reference for the adaption module 204 when determining appropriate unit conversions and mapping the unit to a target unit of a target context based on a unit-to-context relationship with the context of the digital document. The context unit table 300, for instance, uses a multi-dimensional lookup structure configured to associate equivalent units of measurement across different contexts, where classifying features (e.g., document information usable to differentiate between equivalent units across different context) represent inputs to different dimensions of the multi-dimensional lookup structure. The context unit table 300 includes entries for various measurement scenarios, including global metric and imperial systems, regional measurement systems, and domain-specific units. For instance, the context unit table 300 includes mappings for weight units ranging from milligrams to tons, accommodating both scientific precision and industrial-scale measurements. The context unit table 300 also incorporates entries for specialized units like the astronomical “solar mass” or the physics-related “Planck mass,” demonstrating its versatility across different fields of study.

As illustrated in FIG. 3, the context unit table 300 includes multiple columns organizing information about various measurement units. A region column 302 indicates the geographical or contextual region where particular units are commonly used. This region column 302 helps the system identify appropriate units based on regional preferences, such as imperial units for the United States or metric units for other countries.

A unit column 304 lists different units of measurement, including standard units like kilograms and meters, as well as region-specific or domain-specific units like tolas or nautical miles. This comprehensive list of the unit column 304 enables the system 200 to handle a wide range of unit types across various contexts. A format column 306 shows the formatting specifications for how each unit is to be displayed. This facilitates the transcreated expressions to maintain appropriate formatting conventions for different regions or domains. For example, the format column 306 specifies whether to use a dot or comma as a decimal separator, or how to represent compound units. A precision column 308 indicates the number of decimal places or level of precision appropriate for each unit. Information from the precision column 308 is useful for maintaining accuracy in scientific or technical contexts while allowing for appropriate rounding in everyday usage. A usage column 310 provides information about typical applications or scenarios where each unit is used. This contextual information helps the system 200 make more informed decisions when selecting appropriate units for transcreation, especially in domain-specific scenarios.

By organizing unit information in this structured manner, the context unit table 300 enables the transcreation model 116, and the adaption module 204, to efficiently look up and apply appropriate unit conversions based on the context of the digital document and target context. This approach supports accurate and context-aware mathematical transcreation across a wide range of scenarios, from everyday conversions to specialized scientific and technical applications.

FIG. 4 depicts an example unit conversion data structure 400 that is configured as a conversion graph 214 of the example system 200 depicted in FIG. 2. The unit conversion data structure 400 represents relationships between different units of measurement, enabling conversion between diverse unit systems. The conversion graph 214, for instance, is a knowledge graph about distance. This graph-based approach supports the computation of conversion factors 138 for converting numerical quantities 126 associated with units 128 to target quantities 130 associated with target units 132.

The unit conversion data structure 400 includes multiples of nodes 402 connected by edges 404, where each edge 404 has a corresponding conversion factor 406. The nodes 402 represent different units of measurement, including miles node 402(0), kilometers node 402(1), meters node 402(2), millimeters node 402(3), yards node 402(4), centimeters node 402(5), and feet node 402(6). The edges 404 connect pairs of nodes along paths of the conversion graph 214 where direct unit conversion is possible. This forms a sparsely connected (e.g., non-fully connected) graph structure of possible paths of the conversion graph 214 between a unit node and a corresponding targe unit node, which usable to support conversion between different units of measurement represented by the two nodes. For example, the miles kilometers edge 404(0) connects miles node 402(0) to kilometers node 402(1), while kilometers miles edge 404(1) provides the reverse connection. Each edge has a corresponding conversion factor 406, such as miles kilometers factor 406(0) and kilometers miles factor 406(1), which enable bidirectional conversion between connected units.

The unit conversion data structure 400 allows for unit conversion through multiple paths of a graph when direct conversion between two units is not available. For instance, to convert from miles to centimeters, the system 200 determines a path from miles node 402(0) to kilometers node 402(1), then to meters node 402(2), and finally to centimeters node 402(5). The system 200 then combines the intermediate conversion factors along this path.

To determine an efficient conversion path, the system 200 initially identifies a path between a unit node and a target unit node. The system 200 then employs a breadth first search function to identify a shorter path between the unit node and the target unit node. This approach identifies a path with fewer intermediate steps. The breadth first search traverses the nodes along paths of directed edges, combining intermediate conversion factors to compute a corresponding conversion factor for the complete path. For example, to convert from miles to centimeters, an initial path goes through kilometers, meters, millimeters, and then centimeters nodes. The breadth first search then identifies a shorter path going directly from miles to kilometers to meters to centimeters nodes. This efficient pathfinding reduces computational overhead and maintains accuracy by reducing intermediate calculations.

The conversion graph 214 is designed to be updatable, allowing for modifications to existing conversion factors or the addition of new units and relationships. This flexibility is useful for handling dynamic conversions, such as currency exchange rates that change frequently. After updating an intermediate conversion factor along a path, the system efficiently recalculates conversion factors for subsequent conversions using the updated graph structure.

The conversion graph 214 facilitates a multi-stage conversion process by allowing the system to traverse multiple edges to convert between units that are not directly connected. For instance, to convert from miles to centimeters, the system might follow a path from miles node 402(0) to kilometers node 402(1), then to meters node 402(2), and finally to centimeters node 402(5). At each step, the system applies the corresponding conversion factor 406, combining them to produce the final conversion factor. This approach allows for flexible and extensible unit conversions, as new units can be added to the graph without needing to define direct conversion factors to each of the existing units. The multi-stage process also helps maintain accuracy in conversions involving substantially different scales or compound units.

By implementing this graph-based approach, the system achieves efficient storage of conversion factors while maintaining the ability to perform complex multi-step conversions. This design enables the system to handle a wide range of conversion scenarios, from simple unit transformations to intricate conversions involving multiple intermediate steps, while ensuring accuracy and adaptability to changing conversion rates and newly introduced units of measurement.

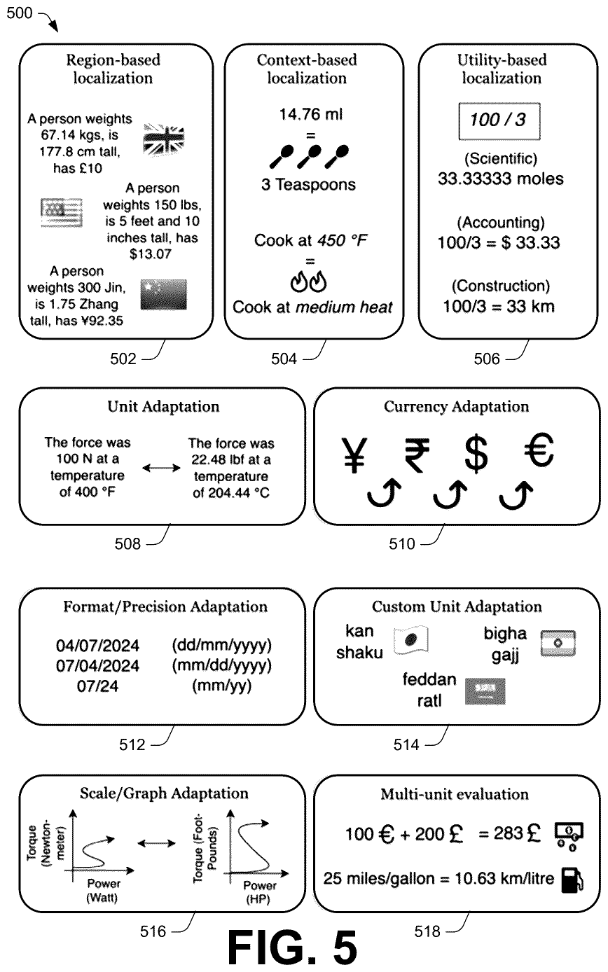

FIG. 5 illustrates examples of mathematical transcreations 500 performed using the techniques described herein related to generative mathematic transcreation. The figure depicts various types of transcreation scenarios and adaptations, demonstrating the versatility and comprehensive nature of the system 200, and the transcreation model 116.

The region localization transcreation 502 is an example of conversions between different regional measurement systems. For instance, weight measurements are shown converted between kilograms and pounds, while height measurements are transformed from centimeters to feet and inches. Currency amounts are also depicted with conversions between pounds, dollars, and yen, accompanied by corresponding regional flags to visually represent the different contexts. Context localization transcreation 504 illustrates the adaptation of measurements for specific contexts, such as cooking. The example demonstrates the conversion of liquid measurements from milliliters to teaspoons, as well as temperature conversions between precise degrees Fahrenheit and more general cooking terms like “medium heat” settings. The system 200 is configured to adapt units, as well as the level of precision and terminology based on the target context. A utility localization transcreation example 506 presents different representations of the same mathematical concept adapted for various professional contexts. The fraction “100/3” is shown transcreated for scientific use (expressed in moles), accounting purposes (represented in currency), and construction applications (conveyed as a distance measurement). This utility localization transcreation example 506 indicates a capability to interpret and transform mathematical expressions based on the intended utility or domain of application.

A unit adaptation transcreation example 508 demonstrates the system 200 proficiency in handling complex scientific measurements. The unit adaptation transcreation example 508 shows conversions of force and temperature measurements between different unit systems, emphasizing the ability to maintain accuracy across diverse scientific and engineering contexts. A currency adaptation transcreation example 510 displays conversion symbols and representations for different currency units, including yen, rupees, dollars, and euros. This currency adaptation transcreation example 510 underscores the system 200 capacity to handle financial calculations and conversions, which are tasked with maintaining up-to-date exchange rates and specific formatting conventions. A format and precision adaptation transcreation example 512 focuses on date format conversions between different regional standards. This format and precision adaptation transcreation example 512 illustrates the system's attention to cultural and regional preferences in data representation, ensuring that information remains clear and contextually appropriate across different locales.

A custom unit transcreation example 514 depicts an ability to work with region-specific and traditional measurement units. Examples include “kan and shaku” used in Japan, “bigha and gajj” common in parts of India, and “feddan and ratl” found in some Middle Eastern countries. Each custom unit is presented alongside a corresponding regional flag, emphasizing the system's comprehensive coverage of diverse and localized measurement systems. A scale and graph adaptation transcreation example 516 demonstrates the system 200 capability to transform visual representations of data. The scale and graph adaptation transcreation example 516 shows torque versus power graphs with axes adapted between Newton-meters and pound-feet units. This transcreation involves not only converting the units but also adjusting the scale and potentially the shape of the graph to accurately represent the data in the new unit system. The system analyzes the original graph structure, identifying various elements such as axis labels, data points, and scales. It then applies appropriately the conversion factors to these elements, recalculating data point positions and adjusting axis scales accordingly. In cases where the relationship between variables is non-linear, the shape of the curve may change to reflect the new unit system accurately. This capability ensures that complex technical information presented in graphical form is accurately transcreated, maintaining the integrity of the data visualization across different unit systems and contexts.

A multi-unit evaluation transcreation example 518 illustrates the system 200 ability to handle complex conversions involving multiple units simultaneously. The multi-unit evaluation transcreation example 518 includes currency conversions combined with fuel efficiency measurements, demonstrating how the system can process and convert compound units like miles per gallon to kilometers per liter while also adjusting for different currencies. The multi-unit evaluation transcreation example 518 is a sophisticated mathematical processing capability of the transcreation model 116, which enables accurate handling of intricate, real-world scenarios involving multiple interrelated units and conversions. Through these diverse examples, FIG. 5 comprehensively illustrates the system 200 and the transcreation model 116 ability to perform context-aware, culturally sensitive, and mathematically accurate transcreations across a wide range of scenarios, supporting the generation of digital content across various data types, applications, and domains, including context-specific documents, tables, charts, graphs, and other digital content.

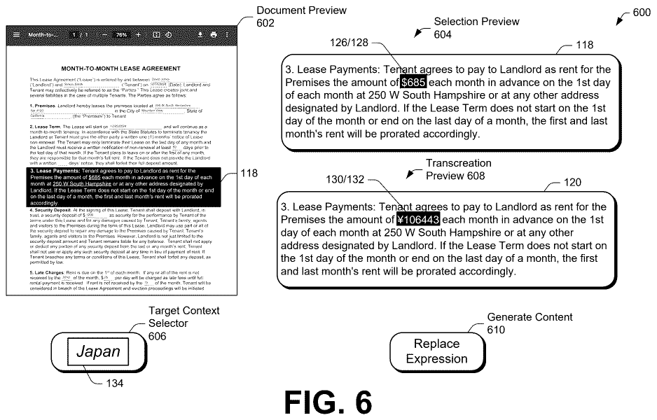

FIG. 6 depicts an example user interface 600 of an example system that implements learning based mathematic transcreation. The user interface 600 is displayed on the display device 112 of the computing device 102 as an example of the user interface 110, for mathematical transcreation.

The user interface 600 includes a document preview 602 displaying a document (e.g., a lease agreement) that describes or expresses numerical data as a mathematical expression 122. This preview allows the user to view the original content, providing context for the transcreation process. A selection preview 604 shows a selected portion of text corresponding to the input 118. The input 118 selects a portion of the document information with the numerical quantities 126 and units 128 of currency. By selecting a portion of text, the transcreation model 116 receives the input 118. This feature enables the user to focus on specific parts of the document for transcreation.

The user interface 600 also includes a target context selector 606 that specifies “Japan” as the target context 134 for the transcreation. The user interacts with the computing device 102 to input different information and in different forms to designate the target context 134. For example, the user speaks to the target context selector 606, and the user interface 600 transcribes the speech input into the target context 134, demonstrating the system's ability to handle various input methods. A transcreation preview 608 displays the mathematical expression 122 transformed into the target mathematical expression 124. Within the transcreation preview 608, target quantities 130 written with target units 132 for the country of Japan (e.g., the target context 134). This transcreation preview 608 allows the user to see the results of the transcreation process in real-time. The input 118 includes original text with rental payment information in US dollars, while the output 120 shows the transcreated text with the payment amount converted to Japanese yen.

A generate content element 610 labeled “Replace Expression” is displayed, allowing the user to initiate the transcreation process with a single click. When activated, this button triggers the conversion between the different numerical representations and units directly within the document. With this interaction, the user automatically transcreates the portion of the lease agreement from US dollars to Japanese Yen, demonstrating the system's efficiency and ease of use. The user interface 600 demonstrates how the system processes and converts numerical expressions between different regional formats while maintaining the original semantic meaning. Through this user interface 600, users of the computing device 102 interact with the transcreation model 116, selecting portions of text for conversion, specifying target contexts, and viewing the results of the mathematical transcreation process. This approach makes complex unit conversions and context-aware mathematical adaptations accessible to users without having specialized knowledge of unit conversion or manual calculation of complex structures.

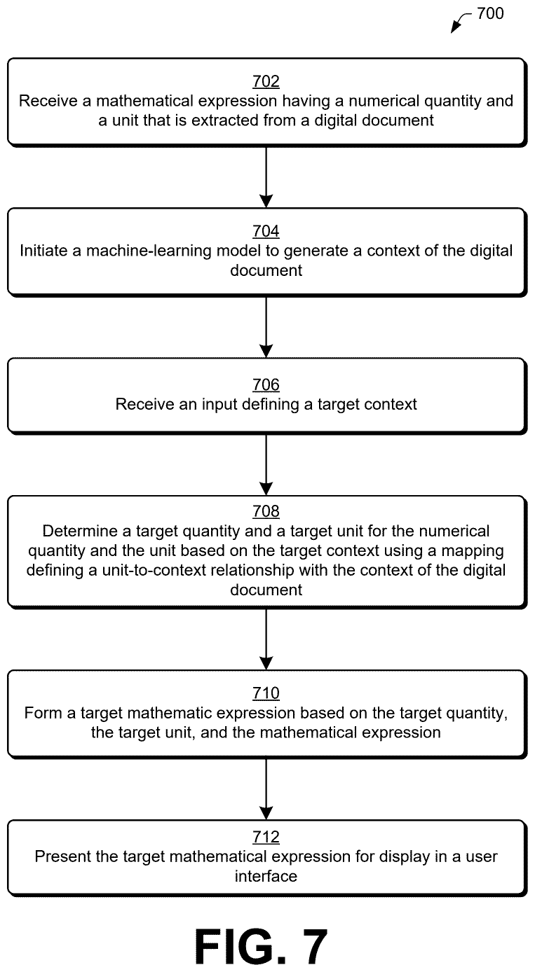

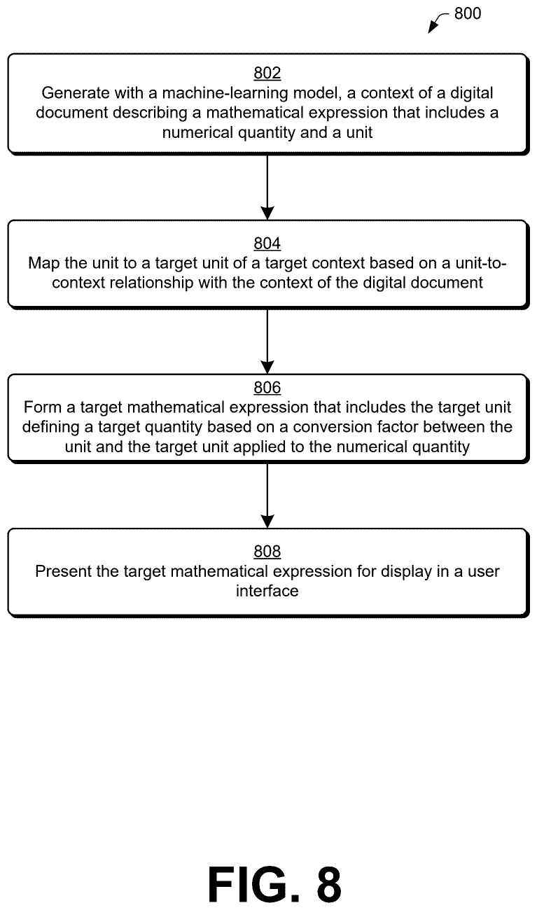

FIG. 7 is a flow diagram depicting an algorithm as a step-by-step process 700, which is performable by a processing device to perform learning based mathematic transcreation. In various examples, the process 700 is performed by the computing device 102, the content processing system 104, the transcreation model 116, the system 200, and so forth, alone or in combination with performing aspects of the process 800, as depicted in FIG. 8.

The process 700 begins at block 702, where the processing device receives a mathematical expression having a numerical quantity and a unit that is extracted from a digital document. The input 118 takes various possible forms, such as a text document, spreadsheet, database query result, image with graphical numerical information, or audio stream including spoken numerical information. The mathematical expression is extracted from the digital document and includes the numerical quantities 126 and the units 128 for processing by the transcreation model 116. In variations, the extraction is performed by the machine-learning model, such as the LLM 210, which identifies the numerical quantities 126 and units 128 from the digital document. The LLM 210, for instance, is configured to search through the input 118 to determine whether the numerical quantities 126 and the units 128 are mentioned, and if not, the LLM 210 or other of the learning models 202 regenerates the extraction and repeats the verification process to eventually arrive at the numerical quantities 126 and the units 128 that are mentioned, described, or conveyed in the input 118.

The process 700 proceeds to block 704, where the processing device initiates a machine-learning model to generate a context of the digital document. The LLM 210 analyzes the input 118, including surrounding text and metadata, to understand the broader context in which the mathematical expression 122 appears. In aspects, the machine-learning model generates a document summary 218 of the digital document, which aids in understanding the context 136. This document summary 218 helps answer questions about the document's region, theme, use of special units, measurement precision, and specific formatting related to ethnic, cultural, or localized settings.

At block 706, the processing device receives an input defining a target context. In variations, the target context 134 defines at least one of a geographic region or a function associated with the input 118. For example, the target context 134 is obtained from user input through the user interface 110, which specifies a conversion from U.S. customary units to metric units, or adaptation of scientific measurements for a general audience.

At block 708, the processing device determines a target quantity and a target unit for the numerical quantity and the unit based on the target context using a mapping, the mapping defining a unit-to-context relationship with the context of the digital document. For example, conversion factors 138 that convert the numerical quantities 126 associated with the units 128 to target quantities 130 associated with the target units 132 are computed. The conversion factors 138 are computed using a mapping such as the conversion graph 214 that represents relationships between different units of measurement. The conversion graph 214 comprises nodes 402 representing individual units and edges 404 each representing a corresponding conversion factor 406 between connected nodes of the nodes 402.

At block 710, the processing device forms a target mathematical expression based on the target quantity, the target unit, and the mathematical expression. The target mathematical expression 124 is formulated in variations using a unit-aware shunting-yard function (e.g., the unit-aware shunting yard module 216), which enables accurate handling of compound unit expressions and complex multi-unit calculations. This function implements a modified unit-aware shunting-yard algorithm that enhances accuracy and efficiency formulating the transcreation, including for compound unit expressions, convoluted expressions, and multi-unit calculations.

The process 700 concludes at block 712, where the processing device presents the target mathematical expression for display in a user interface. The output 120, for instance, includes the target mathematical expression 124 that specifies the target quantities 130 with the target units 132. The target mathematical expression is output for display in the user interface 110 to support transforming numerical concepts between contexts, which is useful for generating context-specific documents, tables, charts, graphs, and other digital content, providing versatility across different data types, applications, and domains.

FIG. 8 is a flow diagram depicting an algorithm as another step-by-step process 800, which is performable by a processing device to perform learning based mathematic transcreation. In various examples, the process 800 is performed by the computing device 102, the content processing system 104, the transcreation model 116, the system 200, and so forth, alone or in combination with performing aspects of the process 700, as depicted in FIG. 7.

The process 800 begins at block 802, where the processing device generates, with a machine-learning model, a context of a digital document describing a mathematical expression that includes a numerical quantity and a unit. This step involves analyzing the digital document of the input 118 with the machine-learning model, such as the LLM 210, including surrounding text and metadata associated with the mathematical expression, to understand the broader context in which the mathematical expression appears in the input 118. The LLM 210 processes the input 118 and generates a document summary 218, from which the context 136 including the numerical quantities 126 and the units 128 is obtained. In variations, the LLM 210 identifies topics, entities, and relationships from the document summary 218, providing a comprehensive understanding of the document in the information included in the context 136. The learning models 202 extract relevant information to determine the context 136, which is provided to the adaption module 204.

The process 800 proceeds to block 804, where the processing device maps the unit to a target unit of a target context based on a unit-to-context relationship with the context of the digital document. This step involves the adaption module 204 performing operations for matching the extracted context information against predefined context categories in the context unit dictionary 212 to determine appropriate unit conversions. The adaption module 204 uses the context unit dictionary 212 to map between the context 136 and target context 134, identifying the target units 132 that are equivalent for the given contexts. In variations, the mapping uses a multi-dimensional lookup structure, such as the context unit table 300 of the context unit dictionary 212 shown in FIG. 3, configured to associate equivalent units of measurement across different contexts, where classifying features (e.g., region column 302, unit column 304, format column 306, precision column 308, and usage column 310) represent inputs to different dimensions of the multi-dimensional lookup structure. The adaption module 204 of the transcreation model 116 shown in FIG. 2 utilizes this multi-dimensional lookup structure for instance to efficiently determine the target units 132 based on the context 136 and target context 134, enabling accurate mapping between equivalent units across different regional, domain-specific, and utility-based scenarios.

At block 806, the processing device forms a target mathematical expression that includes the target unit defining a target quantity based on a conversion factor between the unit and the target unit applied to the numerical quantity. This formation process is performed by the unit converter 206 and the expression module 208 and includes identifying numerical quantities 126 and units 128 in the mathematical expression 122, converting the values using appropriately the conversion factors 138, and replacing the units 128 with target units 132. In variations, the processing device executes a unit-aware shunting yard function to form the target mathematical expression. For example, the unit-aware shunting yard module 216 is configured to transform multi-unit mathematical expressions between different contexts. The unit-aware shunting yard module 216 is unit-aware shunting yard function that tokenizes numerical values and operands of the mathematical expression into a tokenized math expression for the context before creating a reverse polish notation of the tokenized math expression that is formatted and configured to enable sequential processing of the numerical values and operands. From the reverse polish notation based tokenized math expression, the unit-aware shunting yard module 216 computes the target mathematical expression 124 based on the conversion factors 138 by sequentially processing tokens from the reverse polish notation.

The process 800 concludes at block 808, where the processing device presents the target mathematical expression for display in a user interface. This step ensures that the target mathematical expression 124 is presented to the user for final scrutiny in the user interface 110, and optionally stored (e.g., in the storage 108) for future use or reference. The target mathematical expression 124 is output for display in the user interface 110 to support transforming numerical concepts between contexts, which is useful for generating context-specific documents, tables, charts, graphs, and other digital content, providing versatility across different data types, applications, and domains.

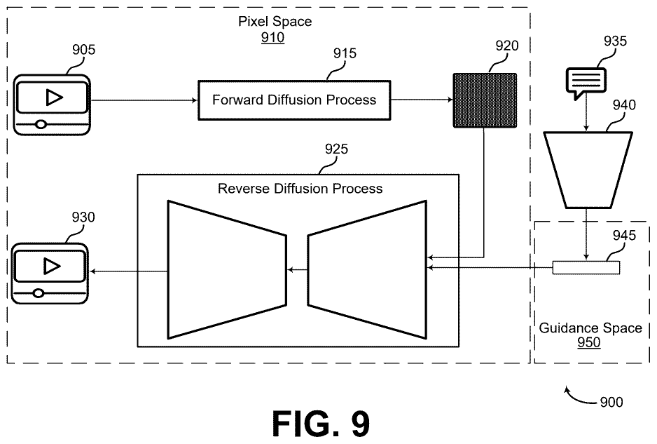

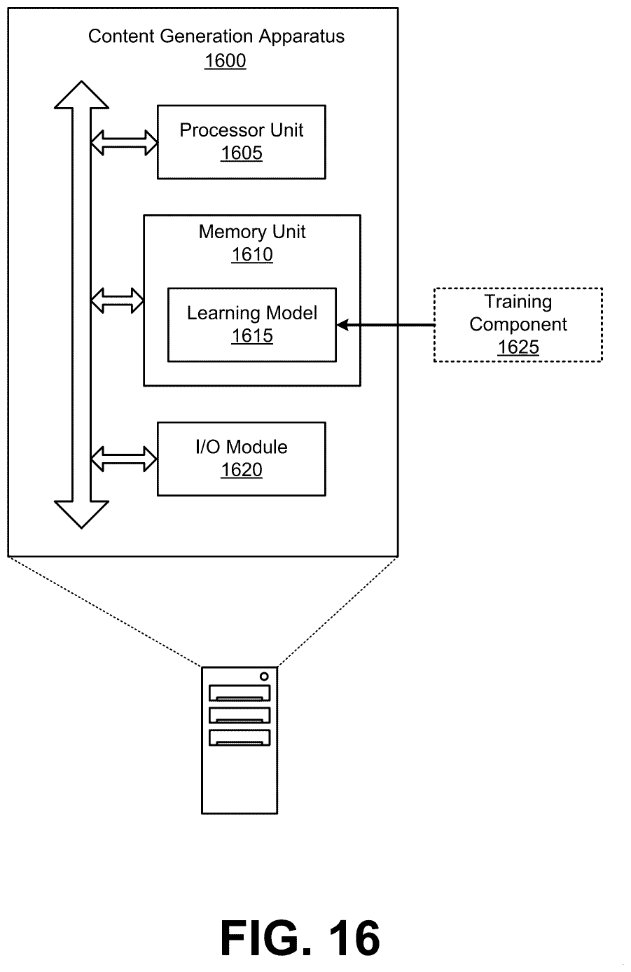

FIG. 9 shows an example of a guided diffusion model 900 according to aspects of the present disclosure. In some examples, guided diffusion model 900 describes the operation and architecture of a learning model 1615 described with reference to FIG. 16.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 900 may take an original media item 905 in a pixel space 910 as input and apply forward diffusion to gradually add noise to the original media item 905 to obtain noisy media item 920 at various noise levels.

Next, a reverse diffusion process 925 (e.g., a U-Net) gradually removes the noise from the noisy media item 920 at the various noise levels to obtain an output media item 930. In some cases, an output media item 930 is created from each of the various noise levels. The output media item 930 can be compared to the original media item 905 to train the reverse diffusion process 925.

The reverse diffusion process 925 can also be guided based on a text prompt 935, or another guidance prompt, such as an image, a layout, a segmentation map, etc. The text prompt 935 can be encoded using a text encoder 965 (e.g., a multimodal encoder) to obtain guidance features 945 in guidance space 950. The guidance features 945 can be combined with the noisy media item 920 at one or more layers of the reverse diffusion process 925 to ensure that the output media item 930 includes content described by the text prompt 935. For example, guidance features 945 can be combined with the noisy features using a cross-attention block within the reverse diffusion process 925.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

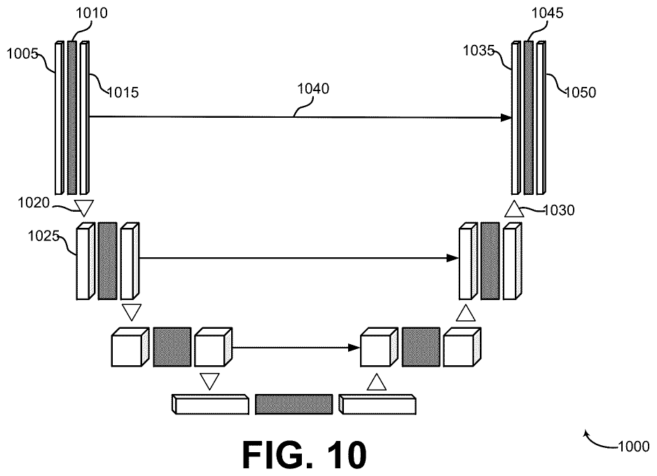

FIG. 10 shows an example of a U-Net 1000 according to aspects of the present disclosure. In some examples, U-Net 1000 is an example of the component that performs the reverse diffusion process 925 of guided diffusion model 900 described with reference to FIG. 9 and includes architectural elements of the learning model 1615 described with reference to FIG. 16. The U-Net 1000 depicted in FIG. 10 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features include a vector representation of an input prompt. The additional input features can be combined with the intermediate features 1015 within the neural network at one or more layers. For example, a cross-attention module can be used to combine the additional input features and the intermediate features 1015.

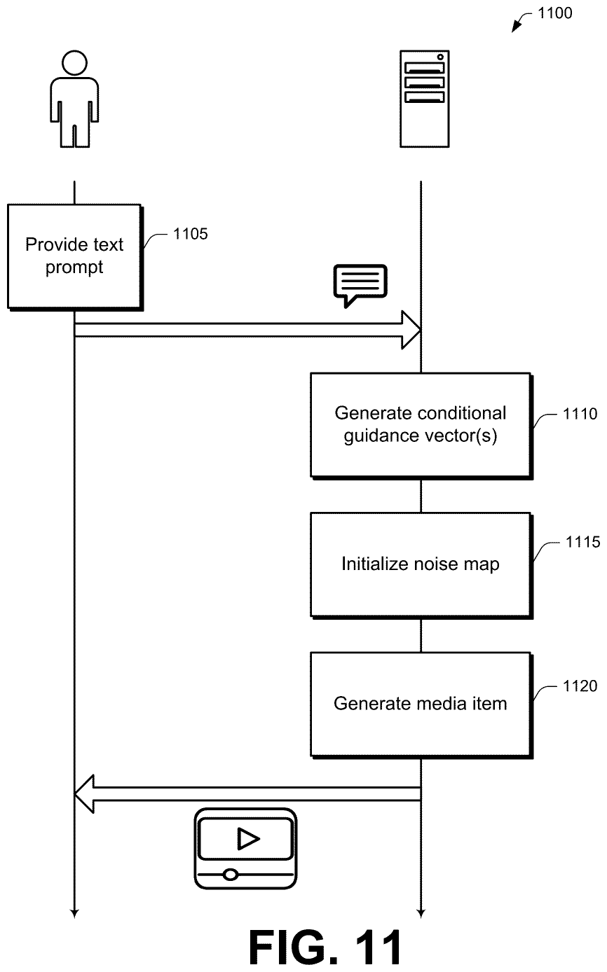

FIG. 11 shows an example of a method 1100 for conditional media generation according to aspects of the present disclosure. In some examples, method 1100 describes an operation of the learning model 1615 described with reference to FIG. 16 such as an application of the guided diffusion model 900 described with reference to FIG. 9. In some examples, these operations are performed by a system including a processor executing a set of codes to control functional elements of an apparatus such as the media generation model described in FIG. 9.

Additionally, or alternatively, steps of the method 1100 may be performed using special-purpose hardware. Generally, these operations are performed according to the methods and processes described in accordance with aspects of the present disclosure. In some cases, the operations described herein are composed of various substeps or are performed in conjunction with other operations.

At operation 1105, a user provides a text prompt describing content to be included in a generated media item. For example, a user may provide the prompt “a person playing with a cat.” In some examples, guidance can be provided in a form other than text, such as via an image, a sketch, or a layout.

At operation 1110, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1115, a noise map is initialized that includes random noise. The noise map may be in a pixel space or a latent space. By initializing a media item with random noise, different variations of a media item including the content described by the conditional guidance can be generated.

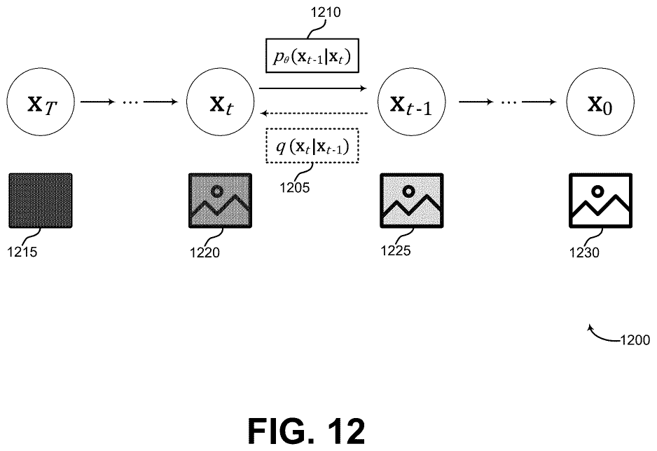

At operation 1120, the system generates a media item based on the noise map and the conditional guidance vector. For example, the media item may be generated using a reverse diffusion process as described with reference to FIG. 12.

FIG. 12 shows a diffusion process 1200 according to aspects of the present disclosure. In some examples, diffusion process 1200 describes an operation of the learning model 1615 described with reference to FIG. 16, such as the reverse diffusion process 925 of guided diffusion model 900 described with reference to FIG. 9.

As described above with reference to FIG. 9, using a diffusion model can involve both a forward diffusion process 1205 for adding noise to a media item (or features in a latent space) and a reverse diffusion process 1210 for denoising the media item (or features) to obtain a denoised media item. The forward diffusion process 1205 can be represented as q(xₜ|xₜ₋₁), and the reverse diffusion process 1210 can be represented as p(xₜ₋₁|xₜ). In some cases, the forward diffusion process 1205 is used during training to generate media items with successively greater noise, and a neural network is trained to perform the reverse diffusion process 1210 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1210, the model begins with noisy data x_{T}, such as a noisy media item 1215 and denoises the data to obtain the p(xₜ₋₁|xₜ). At each step t−1, the reverse diffusion process 1210 takes xₜ, such as first intermediate media item 1220, and t as input. Here, t represents a step in the sequence of transitions associated with different noise levels, The reverse diffusion process 1210 outputs xₜ₋₁, such as second intermediate media item 1225 iteratively until x_{T} reverts back to x₀, the original media item 1230. The reverse process can be represented as:

p_{θ}(xₜ₋₁|xₜ):=N(xₜ₋₁:μ_{θ}(xₜ,t),Σ_{θ}(xₜ,t)) (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}:0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

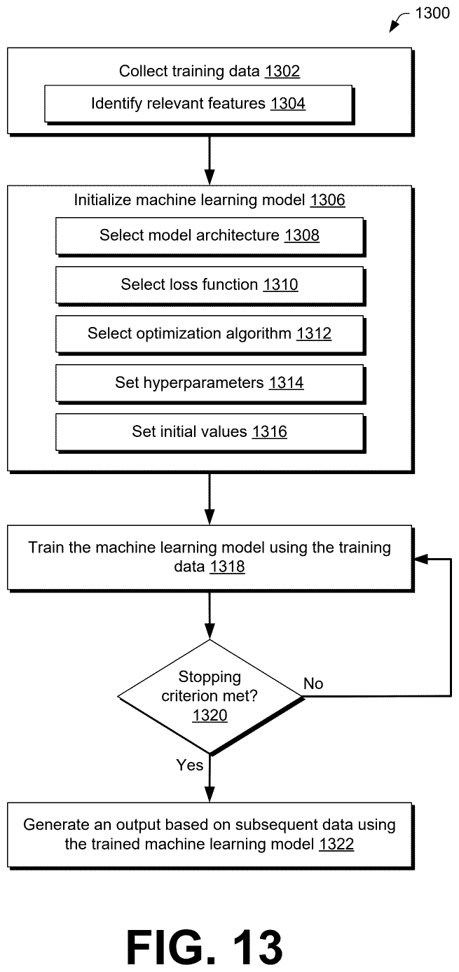

FIG. 13 is a flow diagram depicting an algorithm as a step-by-step procedure 1300 in an example implementation of operations performable for training a machine-learning model. In some examples, the procedure 1300 describes an operation of the training component 1625 described for configuring the learning model 1615 as described with reference to FIG. 16. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (block 1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore, once trained is configured to perform that task based on subsequent data received as an input and processed by the machine-learning model.

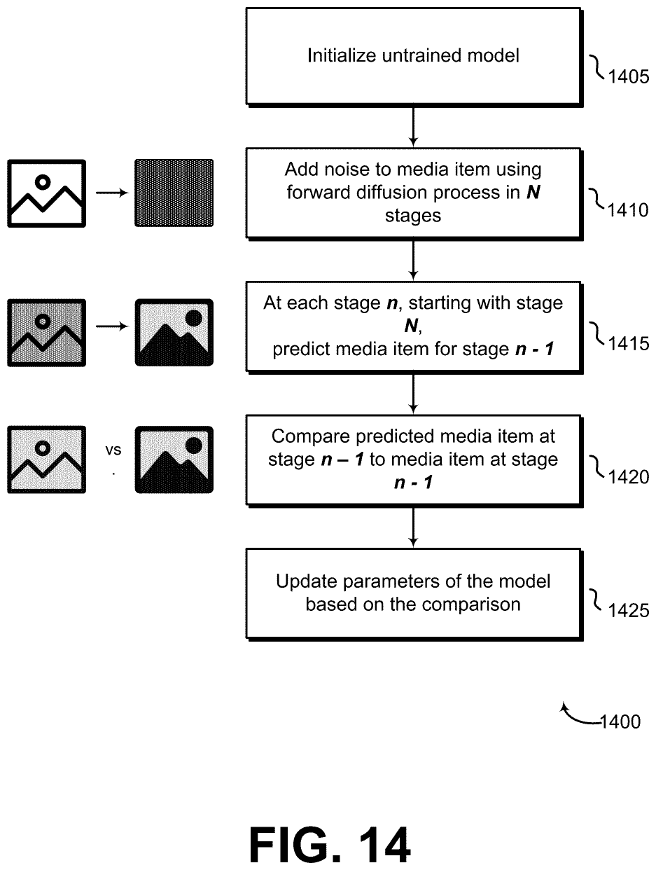

FIG. 14 shows an example of a method 1400 for training a diffusion model according to aspects of the present disclosure. In some examples, the method 1400 describes an operation of the training component 1625 described for configuring the learning model 1615 as described with reference to FIG. 16. The method 1400 represents an example for training a reverse diffusion process as described above with reference to FIG. 12. In some examples, these operations are performed by a system including a processor executing a set of codes to control functional elements of an apparatus, such as the guided diffusion model described in FIG. 9.

Additionally, or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a media item using a forward diffusion process in A stages. In some cases, the forward diffusion process is a fixed process where Gaussian noise is successively added to media item. In latent diffusion models, the Gaussian noise may be successively added to features in a latent space.

At operation 1415, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1425, the system updates parameters of the model based on the comparison. For example, parameters of a U-Net may be updated using gradient descent. Time-dependent parameters of the Gaussian transitions can also be learned.

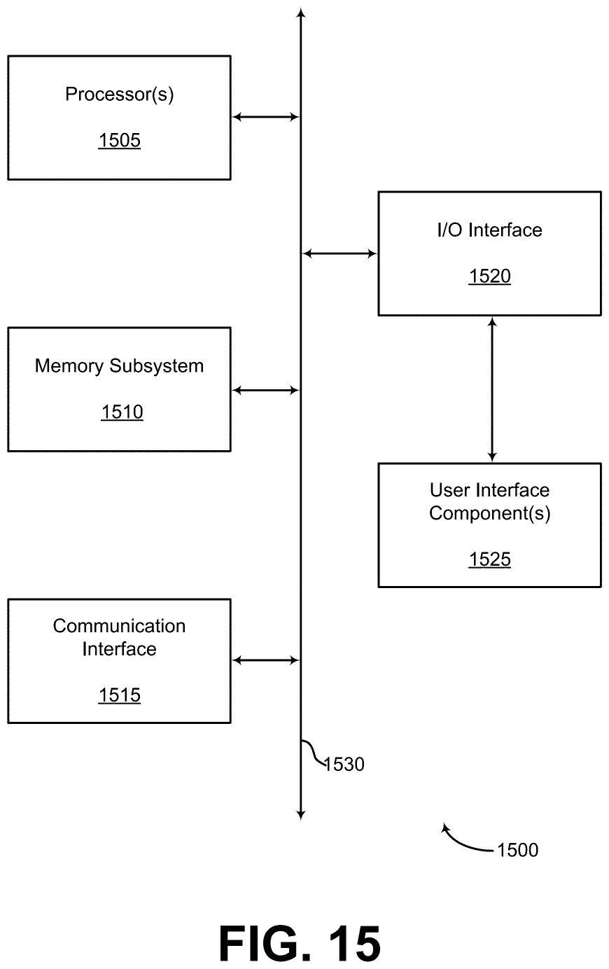

FIG. 15 shows an example of a computing device 1500 according to aspects of the present disclosure. The computing device 1500 may be an example of the content generation apparatus 1600 described with reference to FIG. 16. In one aspect, computing device 1500 includes processor(s) 1505, memory subsystem 1510, communication interface 1515, I/O interface 1520, user interface component(s) 1525, and channel 1530.

In some examples, computing device 1500 is an example of, or includes aspects of, the media generation model of FIG. 9. In some examples, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some examples, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory includes, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of a content generation apparatus 1600 according to aspects of the present disclosure. The content generation apparatus 1600 may include an example of, or aspects of, the guided diffusion model described with reference to FIG. 9 and the U-Net described with reference to FIG. 10. In some examples, content generation apparatus 1600 includes processor unit 1605, memory unit 1610, learning model 1615, I/O module 1620, and training component 1625. Training component 1625 updates parameters of the learning model 1615 stored in memory unit 1610. In some examples, the training component 1625 is located outside the content generation apparatus 1600.

Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, content generation apparatus 1600 uses one or more processors of processor unit 1605 to execute instructions stored in memory unit 1610 to perform functions described herein. For example, the content generation apparatus 1600 may transcreate mathematic expressions from an original math expression to a transcreated math expression for a different context.

The memory unit 1610 may include a learning model 1615 trained to automatically transcreate math expressions using a combination of learning and deterministic techniques. For example, after training, the learning model 1615 may perform inferencing operations as described with reference to FIG. 11 and FIG. 12 to determine the context 136.

In some examples, the learning model 1615 is an Artificial neural network (ANN) such as the guided diffusion model described with reference to FIG. 9 and the U-Net described with reference to FIG. 10. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of learning model 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1625 may train the learning model 1615. For example, parameters of the learning model 1615 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 13 and FIG. 14). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the learning model 1615 can be used to make predictions on new, unseen data (i.e., during inference).

I/O module 1620 receives inputs from and transmits outputs of the content generation apparatus 1600 to other devices or users. For example, I/O module 1620 receives inputs for the learning model 1615 and transmits outputs of the learning model 1615. According to some aspects, I/O module 1620 is an example of the I/O interface 1520 described with reference to FIG. 15.

### Example System and Device

FIG. 17 illustrates an example system 1700 including various components of an example device usable as any type of computing device as described and/or utilized with reference to FIGS. 1-16 to implement examples of the techniques described herein. FIG. 17 illustrates an example system 1700 generally, which includes an example computing device 1702 that is representative of one or more computing systems and/or devices that implement the various techniques described herein. This is illustrated through inclusion of the transcreation model 116. The computing device 1702 is configurable, for instance, as a server of a service provider, a device associated with a client (e.g., a client device), an on-chip system, and/or any other suitable computing device or computing system.

The example computing device 1702 as illustrated includes a processing system 1704, one or more computer-readable media 1706, and one or more I/O interface 1708 that are communicatively coupled, one to another. Although not shown, the computing device 1702 further includes a system bus or other data and command transfer system that couples the various components, one to another. In one or more examples, a system bus includes any one, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1704 is representative of functionality to perform one or more operations using hardware. Accordingly, the processing system 1704 is illustrated as including the hardware elements 1710, which are configurable as processors, functional blocks, and so forth. This includes implementation in hardware as an application specific integrated circuit or other logic device formed using one or more semiconductors. The hardware elements 1710 are not limited by the materials that form the hardware elements 1710, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 1706 is storage media illustrated as including memory/storage 1712. The memory/storage 1712 represents memory/storage capacity associated with one or more computer-readable media. The memory/storage 1712 is configured as a memory component, for example, which is configured to store the digital content 106. The memory/storage 1712 includes volatile media (such as random-access memory (RAM)) and/or nonvolatile media, such as read-only memory (ROM), Flash memory, optical disks, magnetic disks, and so forth. The memory/storage 1712 includes fixed media (e.g., RAM, ROM, a fixed hard drive, and so on) as well as removable media, e.g., Flash memory, a removable hard drive, an optical disc, and so forth. The computer-readable media 1706 is configurable in a variety of other ways as further described below.

Input/output interface(s) 1708 are representative of functionality to allow a user to enter commands and information to computing device 1702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 1702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 1710 include a processing device coupled to the memory component implemented by the memory/storage 1712 to perform operations of the transcreation model 116. The operations, when executed, cause the processing device implemented by the hardware elements 1710 to generate the digital content 106 stored in the memory/storage 1712.

Combinations of the foregoing are also employed to implement various techniques described herein. Accordingly, software, hardware, or executable modules are implemented as one or more instructions and/or logic embodied on some form of computer-readable storage media and/or by one or more hardware elements 1710. The computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing system 1704. The instructions and/or functions are executable/operable by one or more articles of manufacture (e.g., at least one computing device 1702 and/or processing systems 1704) to implement techniques, modules, and examples described herein.

The techniques described herein are supported by various configurations of the computing device 1702 and are not limited to the specific examples of the techniques described herein. This functionality is also implementable or partially implementable through use of a distributed system, such as over a “cloud” 1714 via a platform 1716 as described below.

The cloud 1714 includes and/or is representative of a platform 1716 for resources 1718. The platform 1716 abstracts underlying functionality of hardware (e.g., servers) and software resources of the cloud 1714. The resources 1718 include applications and/or data utilized while computer processing is executed on servers that are remote from the computing device 1702. In at least one example, the resources 1718 include services provided over the Internet and/or through a subscriber network, such as a cellular or Wi-Fi network.

The platform 1716 abstracts resources and functions to connect the computing device 1702 with other computing devices. The platform 1716 also serves to abstract scaling of resources to provide a corresponding level of scale to encountered demand for the resources 1718 that are implemented via the platform 1716. Accordingly, in an interconnected device example, implementation of functionality described herein is distributable throughout the system 1700. The functionality is implementable in part on the computing device 1702 as well as via the platform 1716 that abstracts the functionality of the cloud 1714.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method, comprising:
receiving, by a processing device, a mathematical expression having a numerical quantity and a unit that is extracted from a digital document;
initiating, by the processing device, a machine-learning model to generate a context of the digital document;
receiving, by the processing device, an input defining a target context;
determining, by the processing device, a target quantity and a target unit for the numerical quantity and the unit based on the target context using a mapping, the mapping defining a unit-to-context relationship with the context of the digital document;
forming, by the processing device, a target mathematical expression based on the target quantity, the target unit, and the mathematical expression; and
presenting, by the processing device, the target mathematical expression for display in a user interface.

2. The method of claim 1, further comprising causing the machine-learning model to extract the mathematical expression from the digital document.

3. The method of claim 1, wherein the determining is performed using a knowledge graph having nodes representing respective said units and edges as a conversion factor.

4. The method of claim 3, wherein the forming is performed based on one or more conversion factors computed using the knowledge graph by traversing the edges along a path of the knowledge graph between a unit node and a target unit node.

5. The method of claim 3, wherein the forming is performed based on one or more conversion factors computed using the knowledge graph by combining intermediate conversion factors represented by each edge traversed along a path of the knowledge graph between a unit node and a target unit node.

6. The method of claim 3, wherein the forming is performed based on one or more conversion factors computed using the knowledge graph by executing a breadth first search to determine a shortest path of the knowledge graph between a unit node and a target unit node that includes fewer of the edges between the unit node and the target unit node than each other possible path of the knowledge graph between the unit node and the target unit node.

7. The method of claim 3, further comprising updating an intermediate conversion factor of an edge along a path of the knowledge graph between a unit node and a target unit node to change a corresponding conversion factor between the unit node and the target unit node.

8. The method of claim 1, wherein the presenting includes:
displaying, in the user interface, the mathematical expression within a preview of the digital document;
detecting, from the user interface, the input defining the target context;
automatically replacing the mathematical expression in the digital document with the target mathematical expression; and
displaying, in the user interface, the target mathematical expression in place of the mathematical expression within the preview of the digital document.

9. The method of claim 1, wherein the initiating is performed using the machine-learning model to generate a document summary of the digital document, and by causing the machine-learning model to generate the context of the digital document from the document summary.

10. A system, comprising:
a memory that stores instructions; and
at least one processing device that executes the instructions from the memory to perform operations including:
extracting a mathematical expression having a numerical quantity and a unit from a digital document;
initiating a machine-learning model to generate a context of the digital document;
receiving an input defining a target context;
determining a target quantity and a target unit for the numerical quantity and the unit based on the target context using a mapping, the mapping defining a unit-to-context relationship with the context of the digital document;
forming a target mathematical expression based on the target quantity, the target unit, and the mathematical expression; and
outputting the target mathematical expression for display in a user interface.

11. The system of claim 10, wherein the operations further include:
causing the machine-learning model to extract the mathematical expression from the digital document using a large language model that is trained to identify mathematical expressions from text and images of document inputs.

12. The system of claim 11, wherein the operations further include:
after causing the machine-learning model to extract the mathematical expression, causing the large language model to verify the numerical quantity and the unit correspond to text or image content of the digital document.

13. The system of claim 10, wherein the operations further include:
causing the machine-learning model to generate a document summary of the digital document using a large language model that is trained to generate summaries of document inputs; and
initiating the machine-learning model to generate the context based on classifying features described in the document summary that define the context.

14. The system of claim 13, wherein the classifying features represent inputs to different dimensions of a multi-dimensional lookup structure configured to associate equivalent units of measurement across different contexts to provide the mapping.

15. The system of claim 14, wherein the operations further include:
using the multi-dimensional lookup structure as the mapping to determine the target unit based on a relationship between the inputs and corresponding classifying features of the target context.

16. A system, comprising:
a memory that stores instructions; and
at least one processing device that executes the instructions from the memory to perform operations including:
generating, with a machine-learning model, a context of a digital document describing a mathematical expression that includes a numerical quantity and a unit;
mapping the unit to a target unit of a target context based on a unit-to-context relationship with the context of the digital document;
forming a target mathematical expression that includes the target unit defining a target quantity based on a conversion factor between the unit and the target unit applied to the numerical quantity; and
presenting the target mathematical expression for display in a user interface.

17. The system of claim 16, wherein the operations further include:
executing a unit-aware shunting yard function to form the target mathematical expression, the unit-aware shunting yard function configured to transform multi-unit mathematical expressions between different contexts.

18. The system of claim 17, wherein the unit-aware shunting yard function is configured to tokenize numerical values and operands of the mathematical expression into a tokenized math expression for the context.

19. The system of claim 18, wherein the unit-aware shunting yard function is further configured to create a reverse polish notation of the tokenized math expression to enable sequential processing of the numerical values and operands.

20. The system of claim 19, wherein the unit-aware shunting yard function is configured to compute the target mathematical expression based on the conversion factor and by sequentially processing tokens from the reverse polish notation.
